(19) United States
(12) Patent Application Publication
(10) Pub. No.: US 2026/0281844 A1
(43) Pub. Date: Sep. 17, 2026

(54) NETWORK DEVICES FOR COLLECTING UE RELATED MEASUREMENT IN DUAL CONNECTIVITY

(71) Applicant: Lenovo (Beijing) Limited, Beijing (CN)

(72) Inventors: Congchi Zhang, Shanghai (CN); Mingzeng Dai, Shanghai (CN); Shuigen Yang, Shanghai (CN); Le Yan, Shanghai (CN)

(73) Assignee: Lenovo (Beijing) Limited, Beijing (CN)

(21) Appl. No.: 19/471,334

(22) PCT Filed: Apr. 6, 2023
(86) PCT No.: PCT/CN2023/086701

§ 371 Date: Sep. 30, 2025

(51) Int. Cl. H04W 36/00

(52) U.S. Cl. CPC H04W 36/0085; H04W 36/0069

(57) ABSTRACT

Embodiments of the present disclosure relate to a solution for collecting UE related measurement in dual connectivity. In a solution in accordance with the embodiments of the present disclosure, a network device comprises a processor and a transceiver coupled to the processor. The processor is configured to: transmit, via the transceiver, a first message to request user equipment (UE) related measurement; transmit, via the transceiver, a second message as a part of a dual connectivity procedure for UE to trigger a provision of the UE related measurement for the UE; and in response to completion of the dual connectivity procedure, receive, via the transceiver, a third message that includes the requested UE related measurement related to the dual connectivity procedure. Therefore, the UE related measurement for the UE may be collected in the dual connectivity. The UE related measurement may be provided to the network device to improve network operations.

### FIELD

Embodiments of the present disclosure generally relate to the field of communication, and in particular to network devices for collecting UE related measurement in dual connectivity.

### BACKGROUND

With the development of communication technologies, artificial intelligence (AI) is used to implement network optimization. For example, a very typical workflow for AI based network optimization is that an AI capable next generation base station (gNB) could use all data/measurements collected from one or more user equipment (UE) and neighbor gNBs to train an AI model that can produce inference outputs.

In this case, the gNB could further make a decision and take actions based on the trained AI model. For example, the network actions considered could be switching on/off cells, and/or UE(s) handover to another cell. To monitor if the AI model is performing good and trigger AI model update when necessary, the gNB needs to collect UE related measurements from a target gNB after a UE is handed over to the target gNB. However, there are still some problems to be solved in the collection of UE related measurements.

### SUMMARY

In general, embodiments of the present disclosure provide a solution for collecting a UE related measurement in dual connectivity.

In a first aspect, there is provided a network device. The network device comprises a processor and a transceiver coupled to the processor. The processor is configured to: transmit, via the transceiver, a first message to request user equipment (UE) related measurement; transmit, via the transceiver, a second message as a part of a dual connectivity procedure for UE to trigger a provision of the UE related measurement for the UE, wherein the second message includes a measurement identifier identifying the first message; and in response to completion of the dual connectivity procedure, receive, via the transceiver, a third message that includes the requested UE related measurement related to the dual connectivity procedure.

In a second aspect, there is provided a network device. The network device comprises a processor and a transceiver coupled to the processor. The processor is configured to: receive, via the transceiver, a first message to request user equipment (UE) related measurement; receive, via the transceiver, a second message as a part of a dual connectivity procedure for UE to trigger a provision of the UE related measurement for the UE, wherein the second message includes a measurement identifier identifying the first message; and in response to completion of the dual connectivity procedure, transmit, via the transceiver, a third message that includes the requested UE related measurement related to the dual connectivity procedure.

In a third aspect, there is provided a network device. The network device comprises a processor and a transceiver coupled to the processor. The processor is configured to: receive, via the transceiver, a first message to request user equipment (UE) related measurement; receive, via the transceiver, a second message as a part of a dual connectivity procedure for UE to trigger a provision of the UE related measurement for the UE, wherein the second message includes a measurement identifier identifying the first message; and in response to completion of the dual connectivity procedure, transmit, via the transceiver, a third message that includes the requested UE related measurement related to the dual connectivity procedure.

In a fourth aspect, there is provided a method performed by a network device. The method comprises: transmitting, via the transceiver, a first message to request user equipment (UE) related measurement; transmitting, via the transceiver, a second message as a part of a dual connectivity procedure for UE to trigger a provision of the UE related measurement for the UE, wherein the second message includes a measurement identifier identifying the first message; and in response to completion of the dual connectivity procedure, receiving, via the transceiver, a third message that includes the requested UE related measurement related to the dual connectivity procedure.

In a fifth aspect, there is provided a method performed by a network device. The method comprises: receiving, via the transceiver, a first message to request user equipment (UE) related measurement; receiving, via the transceiver, a second message as a part of a dual connectivity procedure for UE to trigger a provision of the UE related measurement for the UE, wherein the second message includes a measurement identifier identifying the first message; and in response to completion of the dual connectivity procedure, transmitting, via the transceiver, a third message that includes the requested UE related measurement related to the dual connectivity procedure.

In a sixth aspect, there is provided a method performed by a network device. The method comprises: receiving, via the transceiver, a first message from a source secondary node (SN) as a part of a dual connectivity procedure for user equipment (UE), wherein the first message includes a measurement identifier identifying a second message transmitted by a source SN to request a first UE related measurement; and in response to receiving the first message, transmitting, via the transceiver, a third message to a target SN to trigger a provision of a second UE related measurement related to the dual connectivity procedure.

In a seventh aspect, there is provided a computer readable medium. The computer readable medium has instructions stored thereon. The instructions, when executed on at least one processor of a device, causing the device to perform the method of the fourth aspect.

In an eighth aspect, there is provided a computer readable medium. The computer readable medium has instructions stored thereon. The instructions, when executed on at least one processor of a device, causing the device to perform the method of the fifth aspect.

In a ninth aspect, there is provided a computer readable medium. The computer readable medium has instructions stored thereon. The instructions, when executed on at least one processor of a device, causing the device to perform the method of the sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates an example communication system in which some embodiments of the present disclosure can be implemented;

FIG. 2A illustrates an example signalling chart illustrating a process for collecting a UE related measurement in accordance with some example embodiments of the present disclosure;

FIG. 2B illustrates an example signalling chart illustrating a process for collecting a UE related measurement in accordance with some example embodiments of the present disclosure;

FIG. 3 illustrates an example schematic diagram for collecting a UE related measurement in a MN initiated (conditional) SN addition or (conditional) SN change in accordance with some example embodiments of the present disclosure;

FIG. 4 illustrates an example schematic diagram for collecting UE related measurement in a SN initiated (conditional) SN change in accordance with some example embodiments of the present disclosure;

FIG. 5 illustrates another example schematic diagram for collecting a UE related measurement in a SN initiated (conditional) SN change in accordance with some example embodiments of the present disclosure;

FIG. 6 illustrates an example flowchart of an example method implemented at a network device in accordance with some embodiments of the present disclosure;

FIG. 7 illustrates an example flowchart of an example method implemented at a network device in accordance with some embodiments of the present disclosure;

FIG. 8 illustrates an example flowchart of an example method implemented at a network device in accordance with some embodiments of the present disclosure; and

FIG. 9 illustrates an example simplified block diagram of a device that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” and the like indicate that the embodiment described may include a particular feature, structure, or characteristic, but it is not necessary that every embodiment includes the particular feature, structure, or characteristic. Moreover, such phrases do not necessarily refer to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than limitation, a terminal device may also be referred to as a communication device, user equipment (UE), an end user device, a subscriber station (SS), an unmanned aerial vehicle (UAV), a portable subscriber station, a mobile station (MS), or an access terminal (AT). The terminal device may include, but not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device and application (for example, a remote surgery device), an industrial device and application (for example, a robot and/or other wireless devices operating in an industrial and/or an automated processing chain contexts), a consumer electronics device, a device operating on commercial and/or industrial wireless networks, and the like. In the following description, the terms “terminal device,” “communication device,” “terminal,” “user equipment” and “UE” may be used interchangeably.

As used herein, the term “fast master cell group (MCG) link recovery” generally refers to a radio resource control (RRC) procedure in multi-radio dual connectivity (MR-DC) where the UE sends an MCG failure information message to a master node (MN) via the secondary cell group (SCG) upon the detection of a radio link failure on the MCG.

As used herein, the term “master cell group” generally refers to a group of serving cells in MR-DC associated with the master node, comprising of the SpCell (PCell) and optionally one or more SCells.

As used herein, the term “secondary cell group” generally refers to a group of serving cells in MR-DC associated with the Secondary Node, comprising of the SpCell (PSCell) and optionally one or more SCells.

As used herein, the term “secondary node” generally refers to a radio access node in MR-DC, with no control plane connection to the core network, providing additional resources to the UE. It may be an en-gNB (in EUTRA-NR dual connection (EN-DC)), a secondary ng-eNB (in NR-EUTRA dual connectivity (NE-DC)) or a secondary gNB (in new radio-dual connectivity (NR-DC) and NG-RAN E-UTRA-NR dual connectivity (NGEN-DC)).

As used herein, the term “SCG bearer” generally refers to a radio bearer in MR-DC with an radio link control (RLC) bearer (or two RLC bearers, in case of carrier aggregation (CA) packet duplication in an E-UTRAN cell group, or up to four RLC bearers in case of CA packet duplication in a new radio (NR) cell group) only in the SCG.

As used herein, the term “SpCell” generally refers to a primary cell of a master or secondary cell group.

As used herein, the term “signalling radio bearer 3 (SRB3)” generally refers to NGEN-DC and NR-DC, a direct SRB between the SN and the UE in EN-DC.

As used herein, the term “split bearer” generally refers to a radio bearer with RLC bearers both in MCG and SCG in MR-DC.

As discussed above, when monitoring a performance of a AI model, a UE related measurement is collected form a target gNB after the UE is handed over to the target gNB. Such UE related measurement can be used as a measurement to determine if a network (NW) operation decision is good or not. In 3GPP discussion, it has been agreed that a class 1 data collection request/response procedure over an Xn interface is used for the source gNB to request the measurement before handover occurrence (i.e., sending a handover request message). Then, the actual measurement is sent from the target gNB to the source gNB after the handover completion.

Besides, before the source gNB decides to switch off a cell and handover all user equipment (UE) to a neighbour target gNB, the source gNB can use the same class 1 procedure to request an estimated additional energy cost from the target gNB. Then, the source gNB will take into account the estimated additional energy cost at the target gNB when decides to switch off a cell. For example, the source gNB could switch off a cell if the estimated additional energy cost at the target gNB is less than the reduced energy cost at the source gNB.

As discussed above, UE related measurement is collected in the standalone scenario, for example a non-dual connectivity (non-DC) scenario. However, the applicability of such data collection procedures for dual connectivity scenarios has not been discussed in 3GPP, e.g., MN may use a SN to offload some traffic for load balancing, or to save some energy for network energy. Therefore, the performance of the operations in the dual connectivity scenarios cannot be estimated or determined.

In view of the above, embodiments of the present disclosure provide a solution for collecting the UE related measurement in the dual connectivity scenario. For example, a network device may transmit a first message to request user equipment (UE) related measurement. The network device also transmits a second message as a part of a dual connectivity procedure for a UE to trigger a provision of the UE related measurement for the UE. The second message includes a measurement identifier identifying the first message. After the dual connectivity procedure is completed, the network device can receive a third message that includes the requested UE related measurement related to the dual connectivity procedure. Through the solution of the present disclosure, a signaling mechanism may be introduced which allows the network device to collect the UE related measurement in the dual connectivity scenario. Thereby, the UE related measurement may be used to further determine the performance of the operations in the dual connectivity scenarios, and may further be used to determine whether to offload some traffic for load balancing, or to save some energy for network energy.

Principles and implementations of embodiments of the present disclosure will be described in detail below with reference to the figures. However, it is to be noted that these embodiments are given to enable the skilled in the art to implement the solution as proposed herein and not intended to limit scope of the present application in any way.

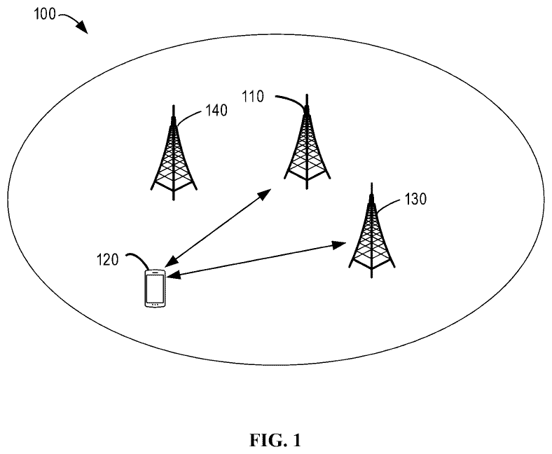

FIG. 1 illustrates an example communication system 100 in which some embodiments of the present disclosure can be implemented. The communication network 100 includes three network devices 110, 130, and 140 and a terminal device 120. The terminal device 120 is also referred as UE equipment. The network devices 110, 130, and 140 can provide services to the terminal device 120 in the dual connectivity scenario. For example, in the dual connectivity scenario, the terminal device 120 can be connected to the network devices 110 and 130.

In the system 100, it is assumed that the terminal device 120 is located within coverage of the network devices 110 and 130. In some examples, a link from the network device 110, 130, or 140 to the terminal device 120 is referred to as a downlink (DL), while a link from the terminal device 120 to the network device 110, 130, or 140 is referred to as an uplink (UL). In downlink, the network device 110, 130, or 140 is a transmitting (TX) device (or a transmitter) and the terminal device 120 is a receiving (RX) device (or a receiver). In uplink, the terminal device 120 is a transmitting TX device (or a transmitter) and the network device 110, 130, or 140 is a RX device (or a receiver). In some embodiments, the network device 110, 130, or 140 and the terminal device 120 may communicate with direct links/channels. DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

Communications in the system 100, between the network device 110, 130, or 140 and the terminal device 120 for example, may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of devices (i.e., the network devices 110, 130, and 140 and the terminal device 120) and their connection relationships and types shown in FIG. 1 are for the purpose of illustration without suggesting any limitation. The system 100 may include any suitable numbers of devices adapted for implementing embodiments of the present disclosure.

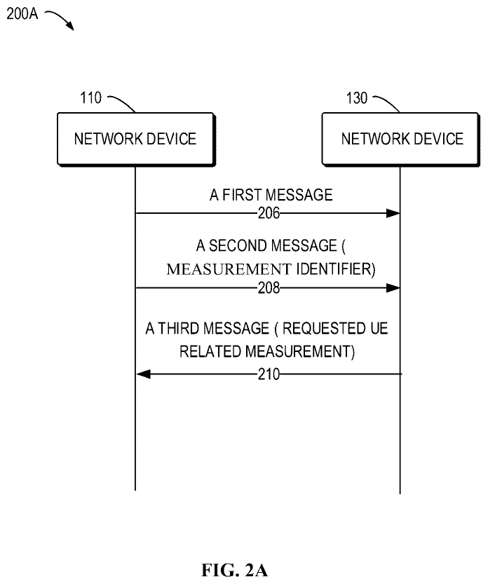

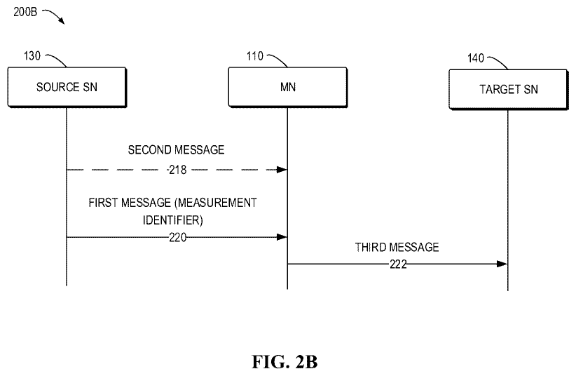

Reference is further made to FIGS. 2A and 2B, which illustrates signalling chart illustrating processes 200A and 200B for collecting UE related measurement in accordance with some example embodiments of the present disclosure. For the purpose of discussion, the processes 200A and 200B will be described with reference to FIG. 1. The process 200A may involve the network devices 110 and 130, and the process 200B may involve the network devices 110, 130, and 140.

As shown in FIG. 2A, the network device 110 transmits 206 a first message to request user equipment (UE) related measurement. The first message is transmitted to the network device 130 and the network device 130 receives the first message. For example, the first message is a DATA COLLECTION REQUEST message.

In some embodiments, the first message is used to indicate the network device 130 to collect UE related measurement, such as UL/DL throughput, Packet delay, Packet error rate, UE mobility/trajectory, UE traffic load, and so on. Alternatively or additionally, the first message includes a measurement identifier which is used to identify the first message.

Additionally, the network device 110 may send multiple messages to multiple network devices, including the network device 130. For example, the multiple messages are transmitted to the several network devices. Each of the multiple messages is transmit to the respective network device to request user equipment (UE) related measurement.

In some embodiments, the first message includes an indicator indicating whether the first message is applied to a handover procedure, a dual connectivity procedure, or both. Thereby, the network device 130 may determine which procedure uses the first message.

In some embodiments, the dual connectivity procedure is a MN initiated secondary node (SN) addition or a MN initiated SN change for the MN and a target SN. As shown in FIG. 2A, in the MN initiated secondary node (SN) addition or a MN initiated SN change, the network device 110 is a master node (MN) and the network device 130 is the SN. The network device 110 may initiate MN initiated (conditional) SN addition or (conditional) SN change.

In some embodiment, after receiving the first message, the network device 130 will send a response message to the network device 110. For example, the response message is a DATA COLLECTION RESPONSE message.

As shown in FIG. 2A, the network device 110 transmits 208 a second message as a part of a dual connectivity procedure for a UE to trigger a provision of the UE related measurement for the UE. The second message includes a measurement identifier identifying the first message. The second message is transmitted to the network device 130 and the network device 130 receives the second message. After the second message is received by the network device 130, the network device 130 needs to collect the UE related measurement. Because the second message contains the measurement identifier identifying the first message, the network device 130 may determine which information is collected based on the first message identified by the measurement identifier. For example, the measurement identifier may be a measurement/event identity.

In some embodiments, the second message may contain a UE identity assigned by the MN, for example, the UE identity assigned by the network device 110. In some embodiments, in the MN initiated (conditional) SN addition or (conditional) SN change, the second message may be a SN ADDITION REQUEST message.

In some embodiment, after receiving the second message, the network device 130 may transmit a acknowledge message to the network device. For example, the acknowledge message is a SN ADDITION ACKNOWLEDGE message.

As shown in FIG. 2A, in response to completion of the dual connectivity procedure, the network device 110 receives 210 a third message that includes the requested UE related measurement related to the dual connectivity procedure. The third message is from the network device 130. For example, the third message may be a DATA UPDATE message.

In some embodiments, in MN initiated (conditional) SN addition or (conditional) SN change, when the dual connectivity procedure for the UE is completed, the network device 110 may send a complete message to the network device 130. For example, the message may be SN RECONFIGURATION COMPLETE message.

In some embodiments, after the dual connectivity procedure for the UE is completed, the network device 130 will collect the requested UE related measurement. The requested UE related measurement is a SN specific UE related measurement measured by the target SN.

In some embodiments, the SN specific UE related measurement is returned to the network device 110 via the third message. The SN specific UE related measurement is embodied in an information element (IE) of the third message. The IE used for the SN specific UE related measurement is the same as an IE used for a UE related measurement for a handover procedure. In one example, the SN specific UE related measurement may include received uplink/downlink (UL/DL) throughput concerning SN terminated master cell group/secondary cell group (MCG/SCG) bearers. In another example, the SN specific UE related measurement may include a packet delay concerning SN terminated master cell group/secondary cell group (MCG/SCG) bearers. In yet another example, the SN specific UE related measurement may include a packet error rate concerning SN terminated master cell group/secondary cell group (MCG/SCG) bearers. In yet another example, the SN specific UE related measurement may include a UE traffic load concerning SN terminated master cell group/secondary cell group (MCG/SCG) bearers. In yet another example, the SN specific UE related measurement may include a received UE mobility/trajectory concerning one or more visited PSCells for the target SN. The above examples are used to illustrate the present disclosure, rather than being used to limit the present disclosure. The SN specific UE related measurement may contain two or more of the received uplink/downlink (UL/DL) throughput, the packet delay, the packet error rate, the UE traffic load, or the received UE mobility/trajectory, or other information.

In some embodiments, an information element (IE) used for the SN specific UE related measurement is different from the IE used for the UE related measurement for the handover procedure. For example, in one example, the SN specific UE related measurement includes average SN terminated uplink/downlink throughput. In another example, the SN specific UE related measurement includes an average SN terminated delay. In yet another example, the SN specific UE related measurement includes an average SN terminated packet error rate. In yet another example, the SN specific UE related measurement includes an average SN terminated traffic load. The above embodiments are used to illustrate the present disclosure, rather than be used to limit the present disclosure.

The SN specific UE related measurement may contain two or more of average SN terminated uplink/downlink throughput, an average SN terminated delay, an average SN terminated packet error rate, or an average SN terminated traffic load, or other information.

In some embodiments, the third message may be received by the network device 110 from the network device 130 as long as the UE is connected to the network device 130.

In DC operations such as SN addition or SN change, the target PSCell is decided by the target SN itself. Therefore, the SN specific UE related measurement can be determined by the network device 130.

FIG. 2A shows the MN initiated (conditional) SN addition or (conditional) SN change. During the process of the MN initiated (conditional) SN addition or (conditional) SN change, the network device 110 is the MN and the network device 130 is the SN. FIG. 2B illustrates an example signalling chart illustrating a process for collecting a UE related measurement in accordance with some example embodiments of the present disclosure.

In FIG. 2B, a SN initiated (conditional) SN change for a source SN, a target SN, and a MN is shown. This process may occur after the process of the MN initiated (conditional) SN addition or (conditional) SN change. In this process, the network device 110 and the network device 130 may also be used to illustrate the communication procedure. In this case, the network device 130 may be used as the source SN, the network device 110 may be used as the MN, and the network device 140 may be used as the target SN. In this process, the operations for network 130 are similar as the operations of the network device 110 shown in FIG. 2A, and the operations for the network device 140 is similar as the operations of the network device 130 shown in the FIG. 2A.

As shown in FIG. 2B, the network device 110 receives 220 a first message from a source secondary node (SN) as a part of a dual connectivity procedure for user equipment (UE). The first message includes a measurement identifier identifying a second message transmitted by a source SN to request a first UE related measurement. The measurement identifier is also referred as the first measurement identifier. In response to receiving the first message, MN 110 transmits 222 a third message to a target SN 140 to trigger a provision of a second UE related measurement related to the dual connectivity procedure. The target SN 140 is the network device that is used by the UE to achieve the dual connectivity procedure.

For SN initiated (conditional) SN change shown in FIG. 2B, there are at least two solutions. A First solution is that the UE related feedback is transmitted from target SN to source SN directly. A second solution is that the UE related feedback is transmitted from target SN to source SN indirectly via a MN. The above operations shown in FIG. 2B are used in the at least two solutions.

In the first solution, the source SN 130 transmits 218 the second message to the target SN 140 directly. The second message is used to request a UE related measurement from the target SN. The UE related measurement can be used to determine that the SN initiated (conditional) SN change is good or not. Alternatively and additionally, the second message includes the measurement identifier identifying the second message. Alternatively or additionally, the second message can include indicators that indicate what information would be obtained from the target SN. For example, the second message is DATA COLLECTION REQUEST message, and the measurement identifier may be measurement/event identity.

In some embodiments, the source SN 130 may transmit a set of messages to a set of candidate SNs to request a UE related measurement. The set of candidate SNs includes the target SN. For the SN initiated SN change, the set of candidate SNs includes one SN. For the SN initiated conditional SN change, the set of candidate SNs includes several SNs. Additionally, after receiving the second message, the target SN 140 may transmit a response message to the source SN. For example, the response message may be a DATA COLLECTION RESPONSE message.

In some embodiments, the first message uses an IE to carry the measurement identifier. For example, the first message is a SN CHANGE REQUIRED message, and the measurement identifier may be used to identify the second message. The IE used for the measurement identifier in the first message may be the same as an IE used for the measurement identifier in the second message. In this case, MN 110 will by default consider the concerned measurement/event ID refers to a data collection request procedure between the source SN and the target SN, in order to avoid a collision with data collection request/response between the source SN and the MN. In some embodiment, an IE used for the measurement identifier in the first message is different from the IE used for the measurement identifier in the second message.

In some embodiment, the first message includes a set of SN identifiers for a set of candidate SNs including the target SN. The first message also includes a set of measurement identifiers. The set of measurement identifiers indicates the messages transmitted to the set of candidate SN. Therefore, the set of measurement identifiers includes the first measurement identifier of the second message that is transmitted to the target SN. Therefore, the set of measurement identifiers corresponds to the set of SN identifiers of the set of candidate SNs. The first message also includes that a first UE identifier of the UE assigned by the source SN.

In some embodiments, in the first solution, the third message transmitted from the MN 110 to the target SN 140 includes a SN identifier for the SN source, a UE identifier of the UE assigned by the source SN, and a measurement identifier identifying the first message transmitted from the source SN 130 to the target SN 140 directly. For example, the third message is a SN ADDITION REQUEST message.

In some embodiments, after the third message is transmitted to the target SN 140, the target SN 140 will transmit a fourth message including a second UE identifier assigned by the target SN to the MN 110. Therefore, the MN 110 may receive the fourth message from the target SN. For example, the fourth message is a SN ADDITION REQUEST ACKNOWLEDGE message.

In some embodiments, the MN 110 transmits a fifth message to the source SN 130. The fifth message includes a set of UE identifiers assigned by the set of candidate SNs. For example, each of the set of candidate SNs receives the fourth message. After the fourth message is received, each candidate SN will assign a UE identifier to the UE. Therefore, the set of UE identifiers is from the set of candidate SNs. Moreover, the set of UE identifiers include the second UE identifier. For example, the fifth message may be SN CHANGE CONFIRM message.

In some embodiment, the source SN 130 receives measurement message from the target SN 140. In one example, the measurement message includes the first UE identifier. In another example, the measurement message includes a second UE identifier of the UE assigned by the target SN. The measurement message also includes the SN specific UE related measurement. The SN specific UE related measurement is discussed above. For example, the measurement message is a DATA UPDATE message.

In the second solution that the UE related feedback is transmitted from target SN to source SN indirectly via MN, the second message is transmitted from the source SN 130 to the MN 110. The second message includes a set of SN identifiers of a set of candidate SNs including the target SN. In the SN initiated SN change, the set of candidate SNs include one SN, which is the target SN. In the SN initiated conditional SN change, the set of candidate SNs include serval SNs, which including the target SN. Additional, the second message also includes the measurement identifier identifying the second message, and indicators indicating the UE related measure to be returned. For example, the second message is DATA COLLECTION REQUEST message.

In some embodiments, after receiving the second message, the MN 110 transmits a sixth message to the target SN 130 to request the second user equipment (UE) related measurement. The second UE related measurement includes the first UE related measurement. For example, the MN 110 may further request more information than that requested by the source SN based on the first UE related measurement. Additionally, the sixth message includes a second measurement identifier identifying the sixth message. For example, the sixth message is a DATA COLLECTION REQUEST message.

In the second solution, the first message is transmitted from the source SN to the MN. The first message also includes the set of SN identifiers of the set of candidate SNs and a set of measurement identifiers corresponding to the set of SN identifiers. For example, one of the set of measurement identifier corresponds to one of the set of SN identifiers. A SN having the one SN identifier receives a message identified by the one measurement identifier. The set of measurement identifiers includes the first measurement identifier. Additionally, the first message also includes a UE identifier of the UE assigned by the source SN.

In some embodiments, in response to receiving the first message, MN 110 transmits a seventh message to the target SN 140. The seventh message includes the second measurement identifier identifying the sixth message transmitted by the MN 110. Additionally, the seventh message includes the UE identifier assigned by the MN 110. For example, the seventh message is a SNADDITION REQUEST message.

In some embodiments, after receiving the seventh message, the target SN 140 transmits an acknowledge message for the seventh message to the MN 110. The acknowledge message includes a UE identifier assigned by the target SN 140. For example, the acknowledge message may be SN ADDITION REQUEST ACKNOWLEDGE message. Then The MN 110 transmits a confirm message to source SN 130. For example, the confirm message is a SN CHANGE CONFIRM message.

In some embodiments, the target SN 140 transmits an eighth message to the MN 110. The eighth message includes a SN specific UE related measurement. For example, the eighth message is a data update message, also be referred as the first data update message. After receiving the eighth message, the MN 110 transmits a second data update message to the Source SN 130. The second data update message at least includes the SN specific UE related measurement. In one embodiment, the second data update message includes a SN specific UE related measurement received by the MN from the target SN, In another embodiment, the second data update message includes the SN specific UE related measurement or/and a MN specific UE related measurement. In yet another example, the second data update message includes an averaged/merged UE related measurement for the MN specific UE related measurement and the SN specific UE related measurement. In some example, the second data update message includes two or more of the SN specific UE related measurement, the SN specific UE related measurement or a MN specific UE related measurement, or an averaged/merged UE related measurement for the MN specific UE related measurement and the SN specific UE related measurement. Additionally, the second data update message also includes a target SN identifier of the target SN.

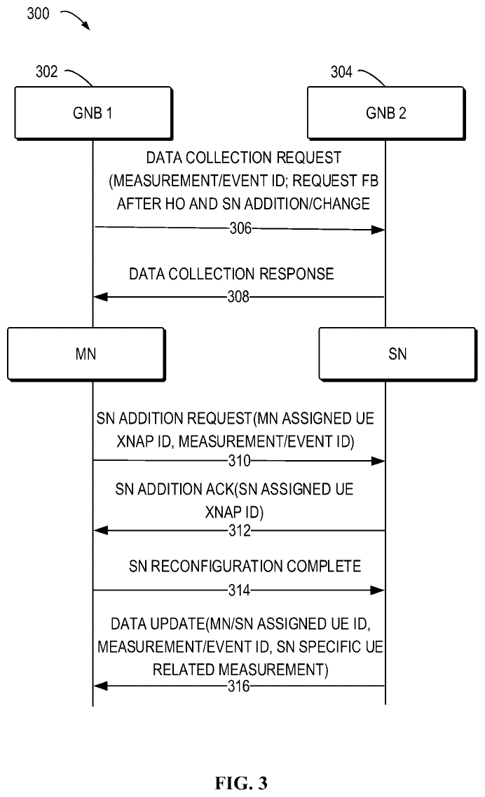

FIG. 3 illustrates an example schematic diagram for collecting UE related measurement in a MN initiated (conditional) SN addition or (conditional) SN change in accordance with some example embodiments of the present disclosure. It is to be understood that the process 300 can be considered as a more specific example of the process 200A as shown in FIG. 2A. Thus, the gNB 1 302 in FIG. 3 may be an example of the network device 110 in FIG. 2A, and the gNB 2 304 in FIG. 3 may be an example of the network device 130 in FIG. 2A.

FIG. 3 shows a process that collects UE related feedback in MN initiated (conditional) SN addition or (conditional) SN change. In this embodiment, gNB 1 302 transmit 306 the DATA COLLECTION REQUEST message to gNb 2 304 to request a UE related measurement from a peer gNB 2 304 after a UE connects to the peer gNB 2 304 as a secondary node in dual connectivity scenario. If the gNB 2 304 accepts the data collection request and replies 308 DATA COLLECTION RESPONSE message, the gNB 1 will transmit 310 SN ADDITION REQUEST message (that contains a Measurement/Event ID referring to a previous request, e.g., same as the Measurement/Event ID contained in the previous request) to gNB 2 304. Then the gNB 2 304 transmits 312 SN ADDITION ACK to the gNB 1 302. The gNB 2 304 should provide 316 the DATA UPDATE including the requested UE related measurement to the gNB 1 302 after receiving an associated SN ADDITION REQUEST and UE connects to gNB #2 successfully. When UE connects to gNB #2 successfully, gNB 1 302 transmits 314 a SN RECONFIGURATION COMPLETE message to gNB 2 304. It is applicable to both MN initiated (conditional) SN addition procedure and (conditional) SN change procedure, wherein the target gNB 2 304 will receive SN ADDITION REQUEST message from MN. The requested UE related measurement can be any of the following: UL/DL throughput, Packet delay, Packet error rate, UE mobility/trajectory, or UE traffic load.

In some embodiments, in the DATA COLLECTION REQUEST message, indicators are added to indicate if the data request applies to handover procedure, or dual connectivity procedures, or both. For example, the request of UL/DL throughput could apply to both handover procedure and dual connectivity procedure, while the request of UE mobility/trajectory could apply to handover procedure. In this way, UE related measurement request for both handover procedure and dual connectivity procedure could be requested in the same DATA COLLECTION REQUEST message.

In some embodiments, the gNB 2 304 starts measuring the accepted/requested UE related measurement after the gNB 2 304 receives 318 the SN RECONFIGURATION COMPLETE message from MN over XnAP interface. After the gNB 2 304 receives the SN RECONFIGURATION COMPLETE message from MN, SN knows UE has applied the SN related radio bearer configuration successfully and can start UL/DL data transfer. In this case, the gNB 1 and the gNB 2 304 are also referred as MN and SN respectively.

In some embodiments, if the requested UE related measurement is accepted, the gNB 2 304 will measure and provide the DATA UPDATE message including the SN specific UE related measurement to the gNB 1 302. The SN specific UE related measurement can be provided by using the same IE as for the UE related measurement provision for handover. In this case, gNB #1 should consider the received UE related measurement is SN specific, e.g.,: the received UL/DL throughput, packet delay, packet error rate, and UE traffic load are only concerning the SN terminated MCG/SCG bearers; the received UE mobility/trajectory is only concerning the visited PSCell(s) and optionally the associated dwelling time. Alternatively, the SN specific UE related measurement can be provided by using different IE than those for the UE related measurement provision for handover, e.g., introducing new IEs in the DATA UPDATE message such as Average SN Terminated Throughput UL/DL, Average SN Terminated Delay, Average SN Terminated Packet Error Rate, Average SN Terminated Traffic Load.

The UE Performance Measurements IE indicates performance measurements for a UE. The Example UE Performance Measurements IE designs of some embodiments are shown in the following table 1.

TABLE 1
Example UE Performance Measurement IE designs of some embodiments

| | | IE type | |
|---|---|---|---|
| | | and | |
| IE/Group Name | Presence | reference | Semantics description |
| Average UE Throughput | O | Protocol | Average overall user plane UE |
| DL | | 9.2.3.4 | throughput in DL |
| Average UE Throughput | O | Protocol | Average overall user plane UE |
| UL | | 9.2.3.4 | throughput in UL |
| Average Packet Delay | O | For | Average value for the delay that a |
| | | Further | packet may experience. |
| | | study | |
| | | (FFS) | |
| Average Packet Error | O | Protocol | Average Packet Error Rate |
| Rate | | 9.2.3.13 | |
| Average SN Terminated | O | | Average overall user plane UE |
| Throughput UL | | | throughput in DL over SN |
| | | | Terminated MCG/SCG bearers |
| Average SN Terminated | O | | Average overall user plane UE |
| Throughput DL | | | throughput in UL over SN |
| | | | Terminated MCG/SCG bearers |
| Average SN Terminated | O | | Average value for the delay that a |
| Packet Delay | | | packet may experience over SN |
| | | | Terminated MCG/SCG bearers. |
| Average SN Terminated | O | | Average Packet Error Rate over SN |
| Packet Error Rate | | | Terminated MCG/SCG bearers |
| Average SN Terminated | O | | Average Traffic Load over SN |
| Traffic Load | | | Terminated MCG/SCG bearers |
| SCG History | O | | |
| Information | | | |

In some embodiments, the target SN will keep providing the requested/accepted UE related measurement as long as UE is connected to the same target SN and does not matter which PSCell UE is connected to. In standalone handover, the target gNB may stop providing the UE related measurement to source gNB if UE is handed over to another cell. This is because during HO procedure, the target PCell is pointed by the source gNB. However, in DC operations such as SN addition or SN change, the target PSCell is decided by the target SN itself.

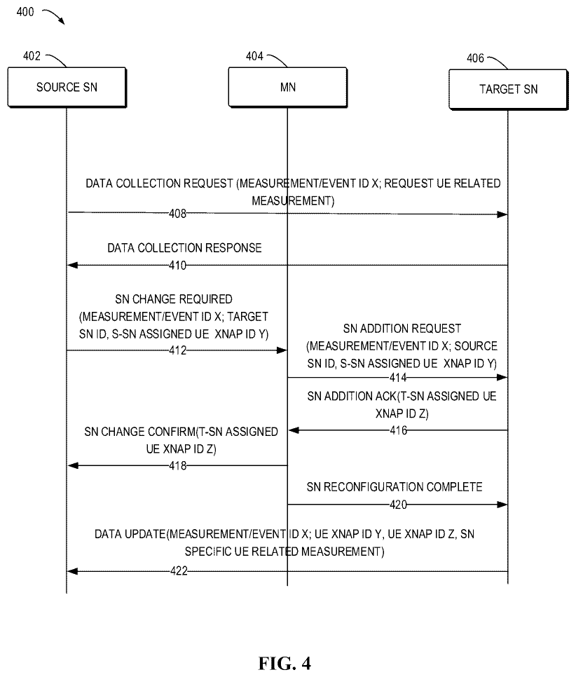

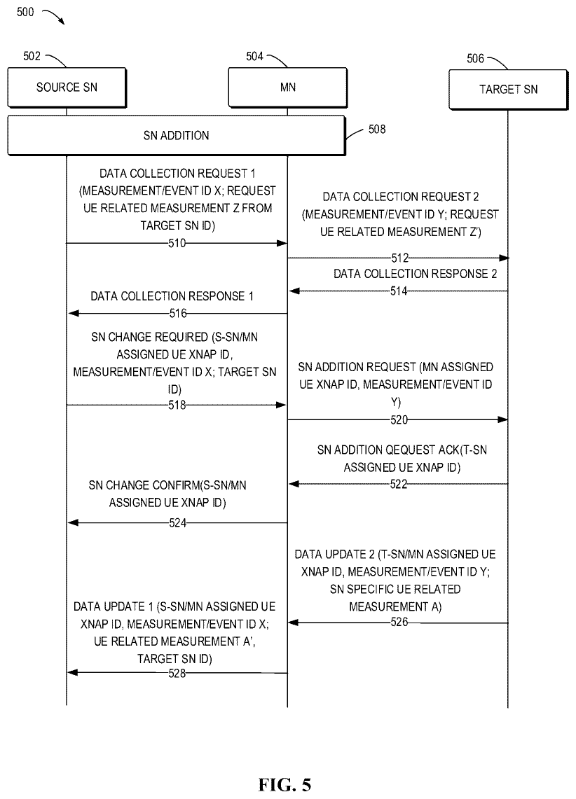

FIGS. 4 and 5 illustrate two solutions of some embodiments for collecting UE related measurements in SN initiated (conditional) SN change. It is to be understood that the process 400 can be considered as a more specific example of the process 200B as shown in FIG. 2B. Thus, the source SN 402 in FIG. 4 may be an example of the source SN 130 in FIG. 2B, the MN 404 in FIG. 4 may be an example of the MN 110 in FIG. 2B, and the target SN 406 in FIG. 4 may be an example of the target SN 140 in FIG. 2B. It is to be understood that the process 500 can be considered as a more specific example of the process 200B as shown in FIG. 2B. Thus, the source SN 502 in FIG. 5 may be an example of the source SN 130 in FIG. 2B, the MN 504 in FIG. 5 may be an example of the MN 110 in FIG. 2B, and the target SN 506 in FIG. 5 may be an example of the target SN 140 in FIG. 2B.

In the embodiments as shown in FIGS. 4 and 5, in case of SN initiated (conditional) SN change, MN will help the source SN to request and receive the UE related measurement from the target SN. If accepted, the UE related measurement will be measured by the target SN and transmitted to the source SN either directly or indirectly via MN. Additionally, the embodiments for FIG. 3 also apply to the embodiments shown in FIG. 4.

FIG. 4 illustrates an example schematic diagram for collecting a UE related measurement collection in a SN initiated (conditional) SN change in accordance with some example embodiments of the present disclosure. Specifically, FIG. 4 shows the solution including that the UE related measurement is transmitted from target SN to source SN directly.

In some embodiments, before the SN initiated (conditional) SN change is triggered by the source SN, source SN initiates the Data Collection Request procedure towards the target SN to request the UE related measurement. As shown in FIG. 4, the source SN 402 transmits 408 a DATA COLLECTION REQUEST message to the target SN 406. Then the target SN 406 transmits 410 a DADA COLLECTION RESPONSE message to the source SN 402 after receiving the DATA COLLECTION REQUEST message. Next, the source SN 402 transmits 412 a SN CHANGE REQUIRED message to the MN 404. The SN CHANGE REQUIRED message triggers the SN initiated (conditional) SN change procedure. In the SN CHANGE REQUIRED message, a Measurement/Event ID that refers to the previous request (e.g., using the same Measurement/Event ID as contained in the previous DATA COLLECTION REQUEST message) is included. When MN sends 414 the SN ADDITION REQUESET message to the target SN, MN shall include the same Measurement/Event ID as in the SN CHANGE REQUIRED message to the target SN. Such that, the target SN can refer to a previous data collection request from source SN based on the Measurement/Event ID received from MN in the SN ADDITION REQUEST message. After receiving the SN ADDITION REQUEST message, the target SN 406 will transmit 416 a SN ADDITION ACKOWNLEDGE message to the MN. The SN ADDITION ACKOWNLEDGE message includes a target-SN (T-SN) ASSIGNED UE XNAP ID Z. Then the MN 404 transmits 418 a SN CHANGE CONFIRM message to the source SN, which also includes a T-SN assigned UE XnAP ID Z. When the UE connects to target SN 406 successfully, the MN 404 transmits 420 a SN RECONFIGURATION COMPLETE message to the target SN 406. Next, the target SN 406 will send 422 a DATA UPDATE message to the source SN 402 directly.

In some embodiments, in the SN CHANGE REQUIRED message, the Measurement/Event ID referring to a data collection request between source and target SN (e.g., using the same Measurement/Event ID as contained in the previous DATA COLLECTION REQUEST message) is contained as a separate IE (e.g., Measurement/Event ID for Target SN IE) compared to the IE used for the data collection request procedure (e.g., Measurement/Event ID IE). Alternatively, the SN specific UE related measurement is contained in the same IE as the IE used for the data collection request procedure. In this case, MN will by default consider the concerned Measurement/Event ID refers to a data collection request procedure between source SN and target SN.

Since there could be data collection request/response between source SN and MN, it is possible that the Measurement/Event ID used between source SN and target SN collides with the Measurement/Event ID used between the source SN and MN. Thus, it is important for MN to distinguish the received Measurement/Event ID refers to the data collection request procedure between source SN and target SN instead of the data collection request procedure between source SN and MN, as in some Embodiments. Then, MN shall ensure the Measurement/Event ID in the SN ADDTITION REQUEST message to the target SN is the same Measurement/Event ID as in the received SN CHANGE REQUIRED message.

In some embodiments, in case of SN initiated conditional SN change, the SN CHANGE REQUIRED message will contain a list of target SN IDs. In this case, the SN CHANGE REQUIRED message could convey a list of Measurement/Event ID and each is associated with a target SN ID.

In some embodiments, in the SN ADDITION REQUEST message sent from MN to target SN, the Measurement/Event ID is provided together with the associated source SN ID and an UE ID Y assigned by the source SN which is contained in the SN CHANGE REQUIRED message received from source SN before (e.g., SN UE XnAP ID). Such that the target SN can refer to a previous data request from the source SN ID precisely, considering the possible Measurement/Event ID collision between the target SN and other gNBs. Also, in legacy, the source SN and target SN do not really know the UE XnAP ID assigned by the counterpart node. To support some embodiments, the UE XnAP ID assigned by the source SN and target SN needs to be forwarded by the MN to the counterpart node.

In some embodiments, in the SN CHANGE CONFIRM message, it may also include the UE ID Z assigned by the target SN for the concerned UE. In case of conditional SN initiated SN change, the SN CHANGE CONFIRM message will include a list of UE IDs each is associated with a target SN ID.

In some embodiments, in the DATA UPDATE message transmitted from the target SN to the source SN could include at least one of the UE ID Y previously assigned by the source SN and the UE ID Z previously assigned by the target SN.

FIG. 5 illustrates another example schematic diagram for collecting a UE related measurement in a SN initiated (conditional) SN change in accordance with some example embodiments of the present disclosure; Specifically, FIG. 5 shows the solution including that the UE related measurement is transmitted from target SN to source SN indirectly via MN.

In some embodiments, SN addition is performed at block 508. The data collection request between source SN and target SN is done in two steps. First, source SN initiates the data collection request procedure with MN. Then, the MN initiates another data collection request towards the target SN to request the UE related measurement as requested previously by the source SN. After the SN initiated (conditional) SN change, the target SN first sends the requested UE related measurement to MN, and MN further forwards to the source SN.

For example, the source SN 502 transmits 510 a DATA COLLECTION REQUEST 1 message to a MN 504. Then the MN 504 transmits 512 a DATA COLLECTION REQUEST 2 message to a target SN 506. As shown in FIG. 5, the measurement/event ID is different. For example, the measurement/event ID X in the DATA COLLECTION REQUEST 1 message is assigned by the source SN 502 to identify the DATA COLLECTION REQUEST 1 message. The measurement/event ID Y in the DATA COLLECTION REQUEST 2 message is assigned by the source SN 502 to identify the DATA COLLECTION REQUEST message. Then a DATA COLLECTION RESPONSE 2 message is transmitted 514 from the target SN 506 to the MN 504 and a DATA COLLECTION RESPONSE 1 message is transmitted 516 from the MN 504 to the source SN 502. The source SN transmits 518 a SN CHANGE REQUIRED message to the MN 504. Next, the MN 504 transmits 520 a SN ADDTITION REQUEST message to the target SN 506. The MN 504 will receive 522 a SN ADDTITION REQUEST ACK message and send 524 a SN CHANGE CONFIRM message to the source SN 502. Then the MN receives 526 a DATA UPDATE 2 message from the target SN 506 and transmits 528 DATA UPDATE 1 message to the source SN 502.

In some embodiments, the DATA COLLECTION REQUEST 1 message also contains the target SN ID that helps MN to identify and request the UE related measurement from the corresponding target SN. In case of SN initiated conditional SN change, the DATA COLLECTION REQUEST could contain a list of target SN IDs.

In some embodiments, the Measurement/Event ID X in DATA COLLECTION REQUEST 1 message is assigned by source SN, the Measurement/Event ID Y in DATA COLLECTION REQUEST 2 message is assigned by MN. X and Y could be same or different values. While the exact UE related measurement Z requested in DATA COLLECTION REQUEST 1 message should be either same as or as a subset of the UE related measurement Z′ requested in DATA COLLECTION REQUESTE 2 message.

In some embodiments, the Measurement/Event ID X assigned by the source SN is from a specific ID pool (e.g., Measurement ID for other Node) that used to assign the Measurement/Event ID that requests data from another gNB (e.g., target SN).

In some embodiments, it is also possible that the Measurement/Event ID X and request UE related measurement Z are conveyed as a container in DATA COLLECTION REQUEST 1 message from source SN to MN. The container is associated with a target SN ID. MN will forward the container to target SN without interpretation. In this case, Measurement/Event ID X and Y, request UE related measurement Z and Z′ are identical.

In some embodiments, in case of SN initiated conditional SN change, the SN CHANGE REQUIRED message will contain a list of target SN IDs. In this case, the SN CHANGE REQUIRED message could convey a list of Measurement/Event ID and each is associated with a target SN ID.

In some embodiments, when MN forwards the requested UE related measurement A′ to the source SN, the MN could provide only the SN specific UE related measurement same as the SN specific UE related measurement A received from the target SN. Alternatively or additionally, the MN may provide both the SN specific UE related measurement and the MN specific UE related measurement, separately. Alternatively or additionally, the MN can provide averaged/merged UE related measurement considering both the MN and SN specific UE related measurement. The SN specific UE related measurement A could be a subset of UE related measurement A′.

In some embodiments, the DATA UPDATE 1 message could also contain the corresponding target SN ID. In case of SN initiated conditional SN change, the source SN may not eventually know to which target SN that UE connects to in the legacy procedure.

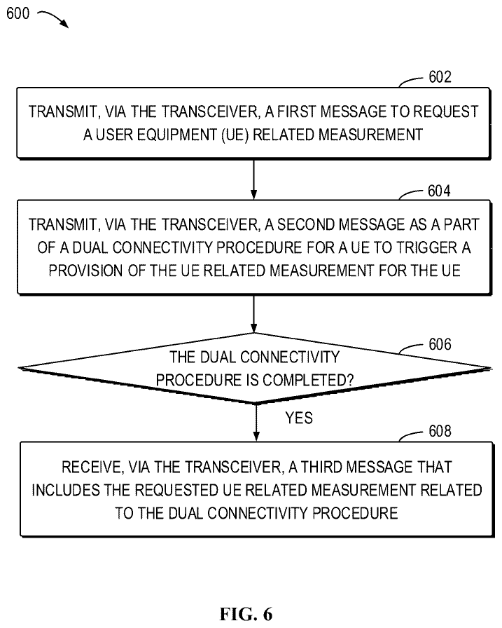

FIG. 6 illustrates an example flowchart of an example method implemented at a network device in accordance with some embodiments of the present disclosure. For the purpose of discussion, the method 600 will be described from the perspective of the network device 110 with reference to FIG. 1.

At block 602, the network device 110 transmits, via the transceiver, a first message to request user equipment (UE) related measurement. At block 604, the network device 110 transmit, via the transceiver, a second message as a part of a dual connectivity procedure for UE to trigger a provision of the UE related measurement for the UE, wherein the second message includes a measurement identifier identifying the first message. At block 606, the network device 110 determines whether the dual connectivity procedure is completed. In response to completion of the dual connectivity procedure, at block 608, the network device 110 receives, via the transceiver, a third message that includes the requested UE related measurement related to the dual connectivity procedure. In response to the dual connectivity procedure not being completed, no operation is performed.

In some embodiments, wherein the first message includes an indicator indicating whether the first message is applied to a handover procedure, a dual connectivity procedure, or both.

In some embodiments, wherein the network device is a master node (MN), and the dual connectivity procedure is a MN initiated secondary node (SN) addition or a MN initiated SN change for the MN and a target SN.

In some embodiments, wherein the requested UE related measurement is a SN specific UE related measurement measured by the target SN.

In some embodiments, wherein an information element (IE) used for the SN specific UE related measurement is the same as an IE used for a UE related measurement for a handover procedure, and the SN specific UE related measurement includes one of: received uplink/downlink (UL/DL) throughput, a packet delay, a packet error rate, or a UE traffic load, or a received UE mobility/trajectory, wherein the received uplink/downlink (UL/DL) throughput, the packet delay, the packet error rate, and the UE traffic load concern SN terminated master cell group/secondary cell group (MCG/SCG) bearers, and the received UE mobility/trajectory concerns one or more visited PSCells for the target SN.

In some embodiments, wherein an information element, IE, used for the SN specific UE related measurement is different from the IE used for the UE related measurement for the handover procedure, and the SN specific UE related measurement includes one of average SN terminated uplink/downlink throughput, an average SN terminated delay, an average SN terminated packet error rate, or an average SN terminated traffic load.

In some embodiments, wherein the third message is received from the target SN as long as the UE is connected to the target SN.

In some embodiments, wherein the network device is a source SN, and the dual connectivity procedure is a SN initiated SN change procedure for the source SN, a master node (MN), and a target SN.

In some embodiments, wherein an IE used for the measurement identifier in the second message is the same as an IE used for the measurement identifier in the first message, or different from the IE used for the measurement identifier in the first message.

In some embodiments, wherein the first message is transmitted to the target SN, and the second message is transmit to the MN and includes: a set of SN identifiers for a set of candidate SNs including the target SN; a set of measurement identifiers, including the measurement identifier and corresponding to the set of SN identifiers; and a first UE identifier of the UE assigned by the source SN.

In some embodiments, the network device 110 receives, via the transceiver and from the MN, a fourth message including a set of UE identifiers for the UE assigned by the set of candidate SNs.

In some embodiments, wherein the third message is received from the target SN, and also includes one of the first UE identifier or a second UE identifier of the UE assigned by the target SN, wherein the set of UE identifiers includes the second UE identifier.

In some embodiments, wherein the first message is transmitted to the MN and includes a set of SN identifiers of a set of candidate SNs including the target SN, and the second message is transmitted to the MN and also includes the set of SN identifiers and a set of measurement identifiers including the measurement identifier and corresponding to the set of SN identifiers.

In some embodiments, wherein the third message also includes a target SN identifier of the target SN.

In some embodiments, wherein the third message is received from the MN, and the requested UE related measurement includes one of a SN specific UE related measurement received by the MN from the target SN, the SN specific UE related measurement or a MN specific UE related measurement, or an averaged/merged UE related measurement for the MN specific UE related measurement and the SN specific UE related measurement.

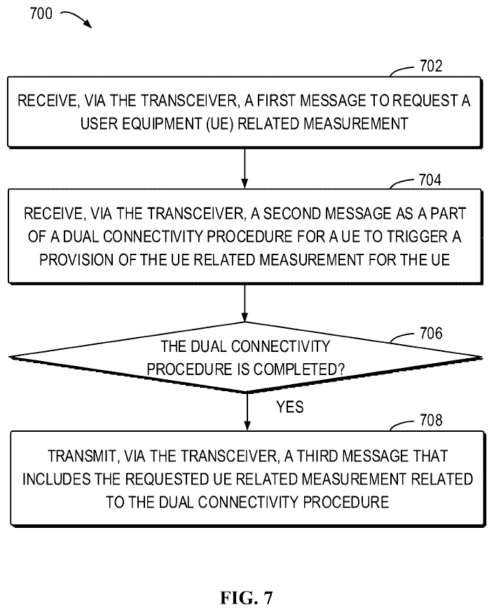

FIG. 7 illustrates an example flowchart of an example method implemented at a network device in accordance with some embodiments of the present disclosure. For the purpose of discussion, the method 700 will be described from the perspective of the network device 130 with reference to FIG. 1.

At block 702, the network device 130 receives, via the transceiver, a first message to request user equipment (UE) related measurement. At block 704, the network device 130 receive, via the transceiver, a second message as a part of a dual connectivity procedure for UE to trigger a provision of the UE related measurement for the UE, wherein the second message includes a measurement identifier identifying the first message. At block 706, the network device 130 determines whether the dual connectivity procedure is completed. In response to completion of the dual connectivity procedure, at block 708, the network device 130 transmits, via the transceiver, a third message that includes the requested UE related measurement related to the dual connectivity procedure. In response to the dual connectivity procedure not being completed, no operation is performed.

In some embodiments, the first message also includes an indicator indicating whether the first message is applied to a handover procedure, a dual connectivity procedure, or both.

In some embodiments, the network device is a target secondary node (SN) and the dual connectivity procedure is a master node (MN) initiated secondary node, SN, addition or a MN initiated SN change for the target SN and a MN.

In some embodiments, the requested UE related measurement is a SN specific UE related measurement for the target SN.

In some embodiments, an information element (IE) used for the SN specific UE related measurement is the same as an IE used for a UE related measurement for a handover procedure, and the SN specific UE related measurement includes one of: received uplink/downlink (UL/DL) throughput, a packet delay, a packet error rate, a UE traffic load, or a received UE mobility/trajectory, wherein the received uplink/downlink (UL/DL) throughput, the packet delay, the packet error rate, and the UE traffic load concern SN terminated master cell group/secondary cell group (MCG/SCG) bearers, and the received UE mobility/trajectory concerns one or more visited PSCells for the target SN.

In some embodiments, an information element (IE), used for the SN specific UE related measurement is different from an IE used for a UE related measurement for a handover procedure, and the SN specific UE related measurement includes one of average SN terminated uplink/downlink throughput, an average SN terminated delay, an average SN terminated packet error rate, or an average SN terminated traffic load.

In some embodiments, the third message is transmitted to the MN as long as the UE is connected to the target SN.

In some embodiments, the network device is a target SN, and the dual connectivity procedure is a SN initiated SN change procedure for a source SN, a master node (MN), and the target SN.

In some embodiments, an IE used for the measurement identifier in the second message is the same as an IE used for the measurement identifier in the first message, or different from the IE used for the measurement identifier in the first message.

In some embodiments, the first message is received from the source SN, and the second message is received from the MN and also includes: a SN identifier for the SN source; and a first UE identifier of the UE assigned by the source SN.

In some embodiments, the network device 130 transmits, via the transceiver and to the MN, a fourth message including a UE identifier assigned by the target SN.

In some embodiments, the third message is transmitted to the source SN, and also includes one of the first UE identifier assigned by the source SN, or a second UE identifier of the UE assigned by the target SN.

In some embodiments, the first message is received from a master node, MN, and the second message is received from the MN.

In some embodiments, the third message is transmitted to the MN, and includes a SN specific UE related measurement.

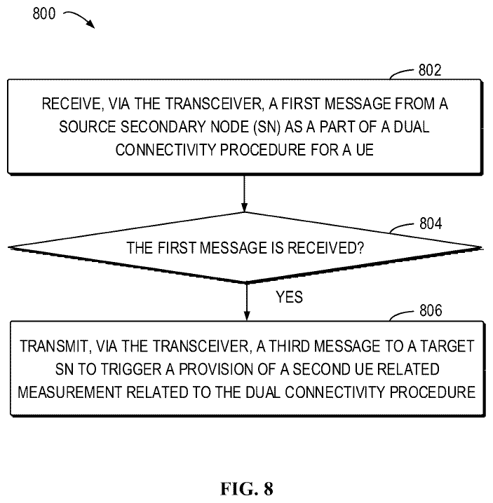

FIG. 8 illustrates an example flowchart of an example method implemented at a network device in accordance with some embodiments of the present disclosure. For the purpose of discussion, the method 800 will be described from the perspective of the network device 110 with reference to FIG. 1.

At block 802, the network device 110 receives, via the transceiver, a first message from a source secondary node (SN) as a part of a dual connectivity procedure for user equipment (UE), wherein the first message includes a measurement identifier identifying a second message transmitted by a source SN to request a first UE related measurement. At block 804, the network device 110 determines whether the first message is received. In response to receiving the first message, at block 806, the network device 110 transmits, via the transceiver, a third message to a target SN to trigger a provision of a second UE related measurement related to the dual connectivity procedure. In response to the first message not being received, no operation is done.

In some embodiments the measurement identifier is a first measurement identifier, and the first message includes: a set of SN identifiers for a set of candidate SNs including the target SN; a set of measurement identifiers, including the first measurement identifier and being corresponding to the set of SN identifiers; and a first UE identifier of the UE assigned by the source SN.

In some embodiments the third message includes: a SN identifier for the source SN; the first measurement identifier; and the first UE identifier.

In some embodiments, the network device 110 receives, via the transceiver and from the target SN, a fourth message including a second UE identifier assigned by the target SN.

In some embodiments, the network device 110 transmits, via the transceiver and to the source SN, a fifth message including a set of UE identifiers assigned by the set of candidate SNs, wherein the set of UE identifiers includes the second UE identifier.

In some embodiments, the second message is received from the source SN and includes a set of SN identifiers of a set of candidate SNs including the target SN, the measurement identifier is a first measurement identifier, and in response to receiving the second message, the network device 110 transmits, via the transceiver, a sixth message to the target SN to request the second user equipment (UE) related measurement, wherein the second UE related measurement includes the first UE related measurement.

In some embodiments, the first message includes the set of SN identifiers and a set of measurement identifiers, wherein the set of measurement identifiers includes the first measurement identifier and corresponds to the set of SN identifiers.

In some embodiments, in response to receiving the first message, the network device 110 transmits, via the transceiver, a seventh message to the target SN including a second measurement identifier identifying the sixth message.

In some embodiments, the network device 110 receives, via the transceiver, an eighth message from the target SN including a SN specific UE related measurement; and transmits, via the transceiver, an ninth message to the source SN including a third UE related measurement, wherein the third UE related measurement at least includes the SN specific UE related measurement.

In some embodiments, the third UE related measurement includes one of the SN specific UE related measurement, the SN specific UE related measurement or a MN specific UE related measurement, or an averaged/merged UE related measurement for the MN specific UE related measurement and the SN specific UE related measurement.

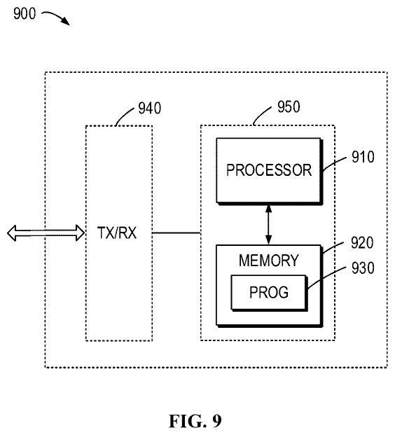

FIG. 9 illustrates a simplified block diagram of a device 900 that is suitable for implementing embodiments of the present disclosure. The device 900 can be considered as a further example implementation of the terminal device 120, and the network devices 110, 130, and 140 as shown in FIG. 1. Accordingly, the device 900 can be implemented at or as at least a part of the terminal device 120, or the network devices 110, 130, or 140.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 930 is assumed to include program instructions that, when executed by the associated processor 910, enable the device 900 to operate in accordance with the embodiments of the present disclosure, as discussed herein with reference to FIGS. 1-8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In summary, embodiments of the present disclosure may provide the following solutions.

Clause 1. A network device comprising: a processor; and a transceiver coupled to the processor, wherein the processor is configured to: transmit, via the transceiver, a first message to request user equipment (UE) related measurement; transmit, via the transceiver, a second message as a part of a dual connectivity procedure for UE to trigger a provision of the UE related measurement for the UE, wherein the second message includes a measurement identifier identifying the first message; and in response to completion of the dual connectivity procedure, receive, via the transceiver, a third message that includes the requested UE related measurement related to the dual connectivity procedure.

Clause 2. The network device of Clause 1, wherein the first message includes an indicator indicating whether the first message is applied to a handover procedure, a dual connectivity procedure, or both.

Clause 3. The network device of Clause 1, wherein the network device is a master node (MN), and the dual connectivity procedure is a MN initiated secondary node (SN) addition or a MN initiated SN change for the MN and a target SN.

Clause 4. The network device of Clause 3, wherein the requested UE related measurement is a SN specific UE related measurement measured by the target SN.

Clause 5. The network device of Clause 4, wherein an information element (IE) used for the SN specific UE related measurement is the same as an IE used for a UE related measurement for a handover procedure, and the SN specific UE related measurement includes one of: received uplink/downlink (UL/DL) throughput, a packet delay, a packet error rate, or a UE traffic load, or a received UE mobility/trajectory, wherein the received uplink/downlink (UL/DL) throughput, the packet delay, the packet error rate, and the UE traffic load concern SN terminated master cell group/secondary cell group (MCG/SCG) bearers, and the received UE mobility/trajectory concerns one or more visited PSCells for the target SN.

Clause 6. The network device of Clause 4, wherein an information element, IE, used for the SN specific UE related measurement is different from the IE used for the UE related measurement for the handover procedure, and the SN specific UE related measurement includes one of average SN terminated uplink/downlink throughput, an average SN terminated delay, an average SN terminated packet error rate, or an average SN terminated traffic load.

Clause 7. The network device of Clause 3, wherein the third message is received from the target SN as long as the UE is connected to the target SN.

Clause 8. The network device of Clause 1, wherein the network device is a source SN, and the dual connectivity procedure is a SN initiated SN change procedure for the source SN, a master node (MN), and a target SN.

Clause 9. The network device of Clause 8, wherein an IE used for the measurement identifier in the second message is the same as an IE used for the measurement identifier in the first message, or different from the IE used for the measurement identifier in the first message.

Clause 10. The network device of Clause 8, wherein the first message is transmitted to the target SN, and the second message is transmit to the MN and includes: a set of SN identifiers for a set of candidate SNs including the target SN; a set of measurement identifiers, including the measurement identifier and corresponding to the set of SN identifiers; and a first UE identifier of the UE assigned by the source SN.

Clause 11. The network device of Clause 10, wherein the processor is further configured to: receive, via the transceiver and from the MN, a fourth message including a set of UE identifiers for the UE assigned by the set of candidate SNs.

Clause 12. The network device of Clause 11, wherein the third message is received from the target SN, and also includes one of the first UE identifier or a second UE identifier of the UE assigned by the target SN, wherein the set of UE identifiers includes the second UE identifier.

Clause 13. The network device of Clause 8, wherein the first message is transmitted to the MN and includes a set of SN identifiers of a set of candidate SNs including the target SN, and the second message is transmitted to the MN and also includes the set of SN identifiers and a set of measurement identifiers including the measurement identifier and corresponding to the set of SN identifiers.

Clause 14. The network device of Clause 13, wherein the third message also includes a target SN identifier of the target SN.

Clause 15. The network device of Clause 13, wherein the third message is received from the MN, and the requested UE related measurement includes one of a SN specific UE related measurement received by the MN from the target SN, the SN specific UE related measurement or a MN specific UE related measurement, or an averaged/merged UE related measurement for the MN specific UE related measurement and the SN specific UE related measurement.

Clause 16. A network device comprising: a processor; and a transceiver coupled to the processor, wherein the processor is configured to: receive, via the transceiver, a first message to request user equipment (UE) related measurement; receive, via the transceiver, a second message as a part of a dual connectivity procedure for UE to trigger a provision of the UE related measurement for the UE, wherein the second message includes a measurement identifier identifying the first message; and in response to completion of the dual connectivity procedure, transmit, via the transceiver, a third message that includes the requested UE related measurement related to the dual connectivity procedure.

Clause 17. The network device of Clause 16, wherein the first message also includes an indicator indicating whether the first message is applied to a handover procedure, a dual connectivity procedure, or both.

Clause 18. The network device of Clause 16, wherein the network device is a target secondary node (SN) and the dual connectivity procedure is a master node (MN) initiated secondary node, SN, addition or a MN initiated SN change for the target SN and a MN.

Clause 19. The network device of Clause 18, wherein the requested UE related measurement is a SN specific UE related measurement for the target SN.

Clause 20. The network device of Clause 19, wherein an information element (IE) used for the SN specific UE related measurement is the same as an IE used for a UE related measurement for a handover procedure, and the SN specific UE related measurement includes one of: received uplink/downlink (UL/DL) throughput, a packet delay, a packet error rate, a UE traffic load, or a received UE mobility/trajectory, wherein the received uplink/downlink (UL/DL) throughput, the packet delay, the packet error rate, and the UE traffic load concern SN terminated master cell group/secondary cell group (MCG/SCG) bearers, and the received UE mobility/trajectory concerns one or more visited PSCells for the target SN.

Clause 21. The network device of Clause 19, wherein an information element (IE) used for the SN specific UE related measurement is different from an IE used for a UE related measurement for a handover procedure, and the SN specific UE related measurement includes one of average SN terminated uplink/downlink throughput, an average SN terminated delay, an average SN terminated packet error rate, or an average SN terminated traffic load.

Clause 22. The network device of Clause 18, wherein the third message is transmitted to the MN as long as the UE is connected to the target SN.

Clause 23. The network device of Clause 16, wherein the network device is a target SN, and the dual connectivity procedure is a SN initiated SN change procedure for a source SN, a master node (MN), and the target SN.

Clause 24. The network device of Clause 23, wherein an IE used for the measurement identifier in the second message is the same as an IE used for the measurement identifier in the first message, or different from the IE used for the measurement identifier in the first message.

Clause 25. The network device of Clause 23, wherein the first message is received from the source SN, and the second message is received from the MN and also includes: a SN identifier for the SN source; and a first UE identifier of the UE assigned by the source SN.

Clause 26. The network device of Clause 25, wherein the processor is further configured to: transmit, via the transceiver and to the MN, a fourth message including a UE identifier assigned by the target SN.

Clause 27. The network device of Clause 25, wherein the third message is transmitted to the source SN, and also includes one of the first UE identifier assigned by the source SN, or a second UE identifier of the UE assigned by the target SN.

Clause 28. The network device of Clause 23, wherein the first message is received from a master node, MN, and the second message is received from the MN.

Clause 29. The network device of Clause 28, wherein the third message is transmitted to the MN, and includes a SN specific UE related measurement.

Clause 30. A network device comprising: a processor; and a transceiver coupled to the processor, wherein the processor is configured to: receive, via the transceiver, a first message from a source secondary node (SN) as a part of a dual connectivity procedure for user equipment (UE), wherein the first message includes a measurement identifier identifying a second message transmitted by a source SN to request a first UE related measurement; and in response to receiving the first message, transmit, via the transceiver, a third message to a target SN to trigger a provision of a second UE related measurement related to the dual connectivity procedure.

Clause 31. The network device of Clause 30, wherein the measurement identifier is a first measurement identifier, and the first message includes: a set of SN identifiers for a set of candidate SNs including the target SN; a set of measurement identifiers, including the first measurement identifier and being corresponding to the set of SN identifiers; and
a first UE identifier of the UE assigned by the source SN.

Clause 32. The network device of Clause 31, wherein the third message includes: a SN identifier for the source SN; the first measurement identifier; and the first UE identifier.

Clause 33. The network device of Clause 31, wherein the processor is further configured to: receive, via the transceiver and from the target SN, a fourth message including a second UE identifier assigned by the target SN.

Clause 34. The network device of Clause 33, wherein the processor is further configured to: transmit, via the transceiver and to the source SN, a fifth message including a set of UE identifiers assigned by the set of candidate SNs, wherein the set of UE identifiers includes the second UE identifier.

Clause 35. The network device of Clause 30, wherein the second message is received from the source SN and includes a set of SN identifiers of a set of candidate SNs including the target SN, the measurement identifier is a first measurement identifier, and wherein the processor is further configured to: in response to receiving the second message, transmit, via the transceiver, a sixth message to the target SN to request the second user equipment (UE) related measurement, wherein the second UE related measurement includes the first UE related measurement.

Clause 36. The network device of Clause 35, the first message includes the set of SN identifiers and a set of measurement identifiers, wherein the set of measurement identifiers includes the first measurement identifier and corresponds to the set of SN identifiers.

Clause 37. The network device of Clause 35, wherein the processor is further configured to: in response to receiving the first message, transmit, via the transceiver, a seventh message to the target SN including a second measurement identifier identifying the sixth message.

Clause 38. The network device of Clause 37, wherein the processor is further configured to: receive, via the transceiver, an eighth message from the target SN including a SN specific UE related measurement; and transmit, via the transceiver, an ninth message to the source SN including a third UE related measurement, wherein the third UE related measurement at least includes the SN specific UE related measurement.

Clause 39. The network device of Clause 38, wherein the third UE related measurement includes one of the SN specific UE related measurement, the SN specific UE related measurement or a MN specific UE related measurement, or an averaged/merged UE related measurement for the MN specific UE related measurement and the SN specific UE related measurement.

Clause 40. A method performed by a network device, comprising: transmitting a first message to request user equipment (UE) related measurement; transmitting a second message as a part of a dual connectivity procedure for UE to trigger a provision of the UE related measurement for the UE, wherein the second message includes a measurement identifier identifying the first message; and in response to completion of the dual connectivity procedure, receiving a third message that includes the requested UE related measurement related to the dual connectivity procedure.

Clause 41. A method performed by a network device, comprising: receiving a first message to request user equipment (UE) related measurement; receiving a second message as a part of a dual connectivity procedure for UE to trigger a provision of the UE related measurement for the UE, wherein the second message includes a measurement identifier identifying the first message; and in response to completion of the dual connectivity procedure, transmitting a third message that includes the requested UE related measurement related to the dual connectivity procedure.

Clause 42. A method performed by a network device, comprising: receiving a first message from a source secondary node (SN) as a part of a dual connectivity procedure for user equipment (UE), wherein the first message includes a measurement identifier identifying a second message transmitted by a source SN to request a first UE related measurement; and in response to receiving the first message, transmitting a third message to a target SN to trigger a provision of a second UE related measurement related to the dual connectivity procedure.

Clause 43. A computer readable medium having instructions stored thereon, which, when executed on at least one processor of a device, causing the device to perform the method according to Clause 40.

Clause 44. A computer readable medium having instructions stored thereon, which, when executed on at least one processor of a device, causing the device to perform the method according to Clause 41.

Clause 45. A computer readable medium having instructions stored thereon, which, when executed on at least one processor of a device, causing the device to perform the method according to Clause 42.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A network device for wireless communication, comprising:
at least one memory; and
at least one processor coupled with the at least one memory and configured to cause the network device to:
transmit a first message to request a user equipment (UE) related measurement;
transmit a second message as a part of a dual connectivity procedure for a UE to trigger a provision of the UE related measurement for the UE, wherein the second message includes a measurement identifier identifying the first message; and
in response to completion of the dual connectivity procedure, receive a third message that includes the requested UE related measurement associated with the dual connectivity procedure.

2. The network device of claim 1, wherein the network device is a master node (MN), and the dual connectivity procedure is a MN initiated secondary node (SN) addition or a MN initiated SN change for the MN and a target SN.

3. The network device of claim 2, wherein the requested UE related measurement is a SN specific UE related measurement measured by the target SN.

4. The network device of claim 3, wherein an information element (IE) used for the SN specific UE related measurement is the IE used for a UE related measurement for a handover procedure, and the SN specific UE related measurement includes one of:
received uplink/downlink (UL/DL) throughput, a packet delay, a packet error rate, a UE traffic load, or a received UE mobility/trajectory,
wherein the received uplink/downlink (UL/DL) throughput, the packet delay, the packet error rate, and the UE traffic load are associated with SN terminated master cell group/secondary cell group (MCG/SCG) bearers, and the received UE mobility/trajectory is associated with one or more visited primary secondary cells (PSCells) for the target SN.

5. The network device of claim 1, wherein the network device is a source secondary node (SN), and the dual connectivity procedure is a SN initiated SN change procedure for the source SN, a master node (MN), and a target SN.

6. The network device of claim 5, wherein an information element (IE) used for the measurement identifier in the second message is the IE used for the measurement identifier in the first message, or different from the IE used for the measurement identifier in the first message.

7. The network device of claim 5, wherein the first message is transmitted to the target SN, and the second message is transmitted to the MN and includes:
a set of SN identifiers for a set of candidate SNs including the target SN;
a set of measurement identifiers, including the measurement identifier and corresponding to the set of SN identifiers; and
a first UE identifier of the UE assigned by the source SN.

8. The network device of claim 7, wherein the at least one processor is further configured to receive, from the MN, a fourth message including a set of UE identifiers for the UE assigned by the set of candidate SNs.

9. The network device of claim 8, wherein the third message is received from the target SN, and includes one of the first UE identifier or a second UE identifier of the UE assigned by the target SN, wherein the set of UE identifiers includes the second UE identifier.

10. The network device of claim 5, wherein the first message is transmitted to the MN and includes a set of SN identifiers of a set of candidate SNs including the target SN, and the second message is transmitted to the MN and includes the set of SN identifiers and a set of measurement identifiers including the measurement identifier and corresponding to the set of SN identifiers.

11. A network device for wireless communication, comprising:
at least one memory; and
at least one processor coupled with the at least one memory and configured to cause the network device to:
receive a first message to request a user equipment (UE) related measurement;
receive a second message as a part of a dual connectivity procedure for a UE to trigger a provision of the UE related measurement for the UE, wherein the second message includes a measurement identifier identifying the first message; and
in response to completion of the dual connectivity procedure, transmit a third message that includes the requested UE related measurement associated with the dual connectivity procedure.

12. A network device for wireless communication, comprising:
at least one memory; and
at least one processor coupled with the at least one memory and configured to cause the network device to:
receive a first message from a source secondary node (SN) as a part of a dual connectivity procedure for a user equipment (UE), wherein the first message includes a measurement identifier identifying a second message transmitted by a source SN to request a first UE related measurement; and
in response to receiving the first message a third message to a target SN to trigger a provision of a second UE related measurement related to the dual connectivity procedure.

13. The network device of claim 12, wherein the measurement identifier is a first measurement identifier, and the first message includes:
a set of SN identifiers for a set of candidate SNs including the target SN;
a set of measurement identifiers, including the first measurement identifier and corresponding to the set of SN identifiers; and
a first UE identifier of the UE assigned by the source SN.

14. The network device of claim 13, wherein the third message includes:
a SN identifier for the source SN;
the first measurement identifier; and
the first UE identifier.

15. The network device of claim 12, wherein:
the second message is received from the source SN and includes a set of SN identifiers of a set of candidate SNs including the target SN, the measurement identifier is a first measurement identifier; and
the at least one processor is further configured to cause the network device to, in response to receiving the second message, transmit a sixth message to the target SN to request the second UE related measurement, wherein the second UE related measurement includes the first UE related measurement.

16. A method performed by a network device, the method comprising:
transmitting a first message to request a user equipment (UE) related measurement;
transmitting a second message as a part of a dual connectivity procedure for a UE to trigger a provision of the UE related measurement for the UE, wherein the second message includes a measurement identifier identifying the first message; and
in response to completion of the dual connectivity procedure, receiving a third message that includes the requested UE related measurement associated with the dual connectivity procedure.

17. The method of claim 16, wherein the network device is a master node (MN), and the dual connectivity procedure is a MN initiated secondary node (SN) addition or a MN initiated SN change for the MN and a target SN.

18. The method of claim 17, wherein the requested UE related measurement is a SN specific UE related measurement measured by the target SN.

19. The method of claim 16, wherein the network device is a source secondary node (SN), and the dual connectivity procedure is a SN initiated SN change procedure for the source SN, a master node (MN), and a target SN.

20. The method of claim 19, wherein an information element (IE) used for the measurement identifier in the second message is the IE used for the measurement identifier in the first message, or different from the IE used for the measurement identifier in the first message.
